(19) United States
(12) Patent Application Publication
(10) Pub. No.: US 2012/0229085 A1
(43) Pub. Date: Sep. 13, 2012

(54) System for charging electric vehicle batteries from street lights and parking meters

(76) Inventor: David M. K. Lau, Hong Kong (HK)

(21) Appl. No.: 12/932,807

(22) Filed: Mar. 7, 2011

(51) Int. Cl. H02J 7/00

(52) U.S. Cl. 320/109; 180/65.21

(57) ABSTRACT

A system for charging batteries of electric vehicles from public fixtures such as street lights and parking meters includes modifying the fixture to convert it to a vehicle battery charging station using a power interface module having a novel keyed electrical power output receptacle connectable to power mains powering the fixture. The system includes a complementarily coded, keyed plug which must be inserted into the power output receptacle to access electrical power from the receptacle, the plug being located at the input end of vehicle charger cable terminated at output end thereof by a vehicle-mounted charge control system which will actuate a charging current contactor permitting charging current to flow from the receptacle to batteries within the vehicle only if a pre-paid charge authorization payment device, such as a magnetically or electronically encoded charge card is inserted into a charger station access enable device such as card reader mounted in the vehicle.

### BACKGROUND OF THE INVENTION

A. Field of the Invention

The present invention relates to methods and apparatus for charging batteries of all-electric and hybrid vehicles. More particularly, the invention relates to a novel system comprised of a method and apparatus which utilize existing electrical power supplied to municipal street lights, parking meters and the like, to charge vehicle batteries, and which relegates paying for charging power to a vehicle mounted apparatus.

B. Description of Background Art

Air pollution resulting from increasing numbers of vehicles powered by internal combustion engines has prompted people worldwide to utilize alternative vehicles. The latter include all-electric vehicles which utilize electric traction motors powered by “on-board” batteries mounted in the vehicle. Hybrid vehicles also use electric motors powered by on-board batteries as a prime mover, but have a small, low-power, low-pollution internal combustion engine which may be used to power the vehicle and to re-charge the batteries if they become substantially discharged while the vehicle is in use.

Both hybrid and all-electric vehicles require that their on-board batteries be re-charged on a regular basis. Re-charging is most often done at a home base of the vehicle, via a cable which is connected at an inner end to a battery charger module located in the vehicle. The outer end of the cable is terminated by a standard electrical power plug which may be connected to utility power mains by inserting the plug in a conventional electric power receptacle, or by a special conversion box or charging apparatus.

With the increasing use of vehicles powered by on-board batteries, there has been an increased demand for charging facilities that enable the operator of an electrically powered vehicle to re-charge vehicle batteries when the vehicle is away from the user's residence or home base. In response to this demand, some governmental agencies have built building and maintaining charging stations for electric vehicles is quite high, which is probably a major reason why such facilities are literally few and far between.

As the number of electric vehicles in regular use increases, problems faced by city governments and vehicle users alike because of an insufficient number of public charging stations available to the users of electric vehicles are rapidly increasing. Accordingly, it would be desirable for governmental agencies to be enabled to utilize existing elements of municipal power grids to provide large numbers of needed electrical vehicle re-charging stations, and at a minimal cost to the government. The desirability of providing a method and apparatus for delivering electricity to charge batteries of electric vehicles which included a large number of charging stations that could use already existing municipal facilities such as street lights and parking meters to thus minimize capital investment outlays by a municipality, was a motive for the present invention.

### OBJECTS OF THE INVENTION

An object of the present invention is to provide a system for charging batteries of electrically powered vehicles parked on city streets and roads.

Another object of the invention is to provide an electric vehicle battery charging system which utilizes electrical power supplied to municipal fixtures such as parking meters and street lights as a source of battery charging current.

Another object of the invention is to provide a system for charging batteries of electric vehicles which includes an accessory power interface module that is readily retro-fittable to an existing street light, parking meter or other such fixture which is supplied with electrical power from municipal power grid mains, to thus enable the fixture to function as an electric vehicle battery charging station while still performing its original intended function such as illuminating a street or receiving parking fees.

Another object of the invention is to provide a system for charging batteries of electric vehicles from municipal power mains, which uses an accessory power receptacle that is readily retro-fittable to an existing municipal facility or fixture such as a parking meter or street light, and which uses vehicle-mounted apparatus components that enable a municipality to obtain payment for electricity supplied to charge vehicle batteries, without requiring installation of payment authorization and accounting equipment at the existing municipal facility.

Another object of the invention is to provide a system for charging batteries of an electric vehicle parked on a street or road from curbside parking meters or street lights, which are modified to function as curbside electric vehicle battery charging stations by the addition of a keyed power output receptacle that will output electrical charging power only to a complementarily keyed plug which is connected through a vehicle charger cable to a vehicle-mounted apparatus that enables power to be drawn from the receptacle only if pre-payment has been made to a municipality or other authorized vending agency.

Another object of the invention is to provide a system for charging batteries of an electric vehicle from a parking meter or street light while the vehicle is parked, using a keyed plug at the end of a vehicle charger cable which extends from the vehicle into a keyed receptacle that extends from the parking meter or street light, the apparatus including a vehicle-mounted safety interlock module which prevents the vehicle from moving while plugged in, yet enables operation of battery-operated vehicle accessories such as air conditioning, radio and lights in the parked vehicle.

Another object of the invention is to provide a system for charging batteries of an electric vehicle from parking meters or street lights which generates a parking and/or charging payment authorization affirming message that is shown on a display device visible from outside the vehicle, and/or accessible by a wireless transponder interrogation device useable by payment enforcement authorities.

Another object of the invention is to provide a system for charging batteries of an electric vehicle which has at the end of a vehicle charger cable that extends from the vehicle multi-terminal electrical plug that has a non-contacting keying device which cooperates with a complementary keying device in a charging power output electrical receptacle located at the end of an electrical cable which is connected to power mains conductors in parking meter or street light, to enable flow of electrical power from the receptacle cable to the vehicle charger cable only if the vehicle charger cable plug keying device presents a correct code to the receptacle.

Another object of the invention is to provide a system for charging batteries of an electric vehicle which utilizes a plug at the end of a vehicle-mounted charging cable that contains a non-contacting keying device which cooperates with a complementary keying device in a power receptacle at the end of a cable that extends from a parking meter or street light to cause an actuator within the receptacle to move an obstructing cover plate which covers the entrance opening of the receptacle to a non-obstructing location which enables the vehicle cable plug to be inserted into the power source receptacle.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated, the present invention comprehends a system for charging batteries of electrically powered vehicles, which utilizes electrical power supplied to existing municipal facilities or fixtures such as street lights and parking meters. According to the invention, a municipal fixture such as a parking meter or street light powered by electrical power mains and located close to the side of a street or road is minimally modified or retrofitted to enable the facility or fixture to function as an electrical vehicle charging station, while the fixture can continue to perform its intended function as a street light, parking meter, etc. The minimal modification includes adding a charging station electrical cable to a fixture which is to be modified and connecting conductors at the inner end of the charging station cable in parallel with load ends power mains conductors within the fixture which are connected at supply ends thereof to a municipal electrical power grid.

The charging station cable which is retrofitted to a municipal fixture includes a novel keyed tamper-resistant and weather-resistant charging power output electrical receptacle located at the outer, load end of the charging station cable. The charging power output receptacle contains an electro-mechanical or solid state electronic contactor, and a novel arrangement of keyed conductive and non-conductive pins, which enable electrical power to be drawn from the receptacle only by a correctly keyed plug of novel design and construction, the plug comprising another part of the invention.

According to the invention, only vehicles which have had installed at the time of manufacture or as an after-market accessory novel vehicle mounted components of the system comprising an On-Board Charge Control System may obtain electrical power from a keyed power receptacle. The On-Board Charge Control System includes electrical and electronic components mounted within a vehicle which are connected to a vehicle charger electrical cable that is terminated at an outer, input end thereof by the novel keyed plug.

Vehicle-mounted components of the On-Board Charge Control system according to the invention include a Charging Current Controller module which controls charging current supplied to an existing main or master bank of batteries that power the vehicle, as well as auxiliary batteries. The Charging Current Controller module provides an electrical charge authorization or charging station access signal to an electromagnetic or solid state electronic power contactor relay located within an Automatic Power Off (APO) module that is connected in series with the vehicle charger cable and a main, master battery bank within the vehicle.

The charge authorization signal actuates the APO power contactor relay to thus enable charging current to flow from the charging station power output receptacle to the vehicle batteries only if a prepaid, magnetically or electronically encoded charge card such as a SIM card issued by a municipality or other authorized agency is inserted into a card reader slot in the Charging Current Controller module.

The Charging Current Controller module deducts from a prepaid money balance on the charge card money amounts proportional to the product of electric charging power drawn from an electric vehicle charging station, multiplied by a predetermined cost per unit of power.

As long as a positive money balance remains on the charge card, the APO will be enabled by a signal from the Charging Current Controller module to conduct current from the charging station receptacle mounted on the street light or parking meter to the vehicle in which the apparatus is mounted.

According to the invention, electrical current from a municipal facility or fixture such as a parking meter or street light is paid for in advance by an electrical vehicle user, and as current flows to the vehicle, an electrical power meter or coulomb charge meter in the vehicle deducts from a money credit balance on a charge card an amount equal to the product of power or charge outputted to the vehicle, multiplied by the rate in dollars, e.g., yuan, yen, etc. per unit of charge or power. When the money balance on the charge card decreases to zero, the charging station access enable signal provided to the power contactor relay in the APO by the Charging Current Controller module is removed, preventing any further current to be drawn by a particular vehicle from the charger receptacle.

The Charging Current Controller module in the vehicle also has an excess charge or “battery overflow” sensor input port which disables charging power by removing the charge enable signal to the APO, if an excess charge, charge rate or over-voltage sensor connected to the vehicle batteries and input to the Charging Current Controller module detects an excess battery charge rate, excess battery charge or over-voltage condition.

In a preferred embodiment of an electric vehicle charging apparatus and system according to the present invention, the vehicle is provided with one or preferably two auxiliary batteries. The auxiliary batteries are used to power automobile accessories such as lights, radio and air-conditioner, for the safety, convenience and comfort of occupants of a vehicle, while the master battery for powering the vehicle traction motor is being charged.

Also according to the invention, provision is made for charging one or more selected auxiliary batteries, when, for example, the vehicle is parked at a parking meter which has been modified to function as a charging station . Thus, in a preferred embodiment of the invention, selected combinations of the master battery, first auxiliary battery, or first and second auxiliary batteries can be charged by operating selector switches located on a control panel of the Charging Current Controller Module. For example, a first, master battery charge switch can be operated to enable charging the master battery of a vehicle at a relatively high current rate, at a first high dollar per hour rate, of, for example, two dollars per hour. Similarly, if it is desired to charge one or both auxiliary batteries, the control panel of the Charging Current Controller Module can be provided with second and third switches for enabling intermediate charging currents to flow to both or one auxiliary batteries at, for example, one dollar per hour or 50 cents per hour, respectively.

According to the invention, the On-Board Charge Control System mounted in a vehicle includes a safety interlock mechanism to prevent electrical power from being supplied to the vehicle traction motor while the vehicle charging plug is inserted into the charging station street receptacle. In a preferred embodiment, the safety interlock mechanism is implemented by a vehicle Drive Enable module connected in series with the vehicle battery and traction motor controller. The vehicle Drive Enable module prevents current from flowing to the vehicle drive motor unless the plug at the end of the vehicle charger cable is removed from the street charging station receptacle and inserted into a similarly constructed receptacle on the Charging Current Controller Module, which provides an enabling signal to the Drive Enable module only when the plug is inserted into the receptacle of the Charging Current Controller Module.

Preferably, the system for charging electric vehicle batteries from street lights and parking meters according to the present invention includes a verification device which enables police, meter maids or other payment enforcement personnel to confirm that a vehicle connected to a charging station is authorized to receive electrical power from the charging station. The verification device in one embodiment of the invention consists of a visual display device which is mounted inside the vehicle and viewable through a window of the vehicle by enforcement personnel. The display device can confirm that the vehicle is receiving power which has been paid for, and is legally entitled to be parked at a metered location. Optionally, an on-board component of the street charging system apparatus can include a wireless transponder which operates at radio or infrared frequencies and can be interrogated by enforcement personnel on foot or in a patrol vehicle, using a radar gun-type of transponder interrogation device, to confirm that a vehicle is authorized to receive charging power.

The electric vehicle charging system according to the present invention may optionally include an enhancement such as an additional electronic interlock relay located with the power outlet receptacle, which requires the presence of correctly coded RFID chip in the plug at the end o the vehicle charger cable, to enable current to flow to the plug. Also, the receptacle may optionally include an obstructing security cover plate which covers the entrance opening to the receptacle against rain, snow and the like, and further secures the receptacle against being tampered with or subjected to unauthorized use. In this embodiment, the security cover plate is operable by an electro-mechanical actuator such as an electric motor or solenoid within the receptacle, which is energized by electronic sensing and control circuitry only when a correctly coded mechanical, magnetic or electronic key such as an RFID chip is presented to the receptacle.

For further security, the power cable disposed between the power main and power receptacle may be shortened, and the receptacle hard-mounted to the standard of a parking meter or light pole.

Also, the charging system according to the present invention may optionally include an inductive magnetic coupler connected in a series with the vehicle charger cable.

### BRIEF DESCRIPTION OF THE DRAWINGS

FIG. 1A is a pictorial view of a system for charging electric vehicle batteries from street lights and parking meters according to the present invention.

FIG. 1B is an enlarged, partly broken away view of a vehicle being charged by apparatus components of the system of FIG. 1A.

FIG. 2 is a block diagram of the system of FIGS. 1A and 1B.

FIG. 3 is a perspective view of a novel tamper-resistant and weather-resistant power receptacle comprising part of the system and apparatus of FIGS. 1A, 1B and 2.

FIG. 4 is a perspective view of a novel power plug for use with the receptacle of FIG. 3 and comprising part of the system and apparatus of FIGS. 1A, 1B and 2.

FIG. 5 is a partly diagrammatic view of the receptacle of FIG. 3 and plug of FIG. 4.

FIG. 6 is a partly diagrammatic view of a first type of bridging connector pin-pair and mating receptacle socket ferrules of the plug of FIG. 4 and receptacle of FIG. 3.

FIG. 7 is a partly diagrammatic view of a second type of a connector pin-pair and mating receptacle socket ferrules of the plug of FIG. 4 and receptacle of FIG. 3.

FIG. 8 is a diagrammatic view of an alternate embodiment of the receptacle and socket of FIG. 5.

FIG. 9 is a fragmentary pictorial view of the system and apparatus of FIGS. 1A and 1B, showing vehicle mounted components of the system.

FIG. 10 is a partly diagrammatic longitudinal sectional view of an optional magnetic coupler shown in FIG. 9.

FIG. 11 is a partly diagrammatic view of an Automatic Power Off (APO) component of the system of FIGS. 1A, 1B, 2 and 9.

FIG. 12 is a pictorial view of a vehicle mounted Charging Current Controller module of the system of FIGS. 1A, 1B, 2 and 9.

### DESCRIPTION OF THE PREFERRED EMBODIMENTS

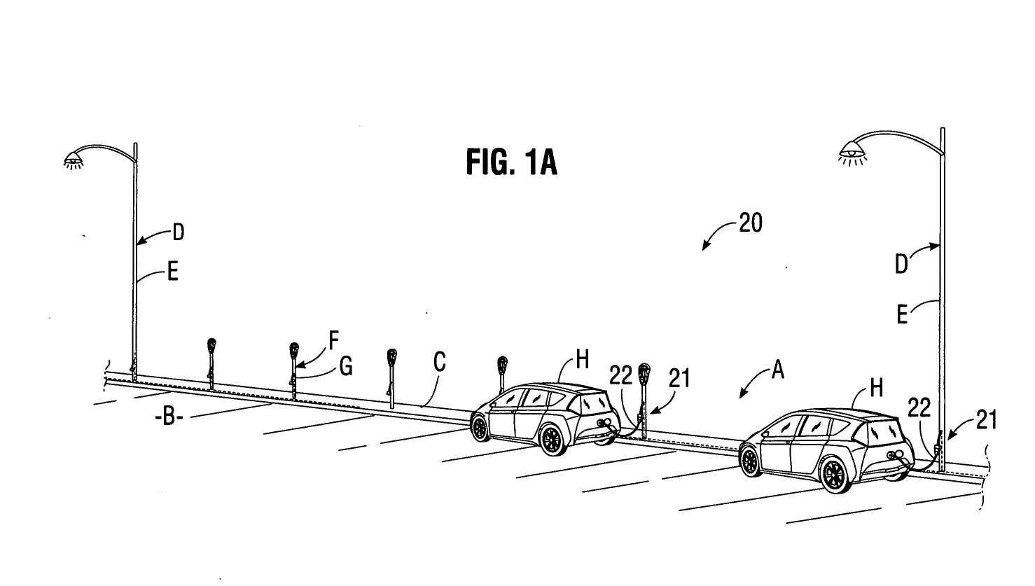

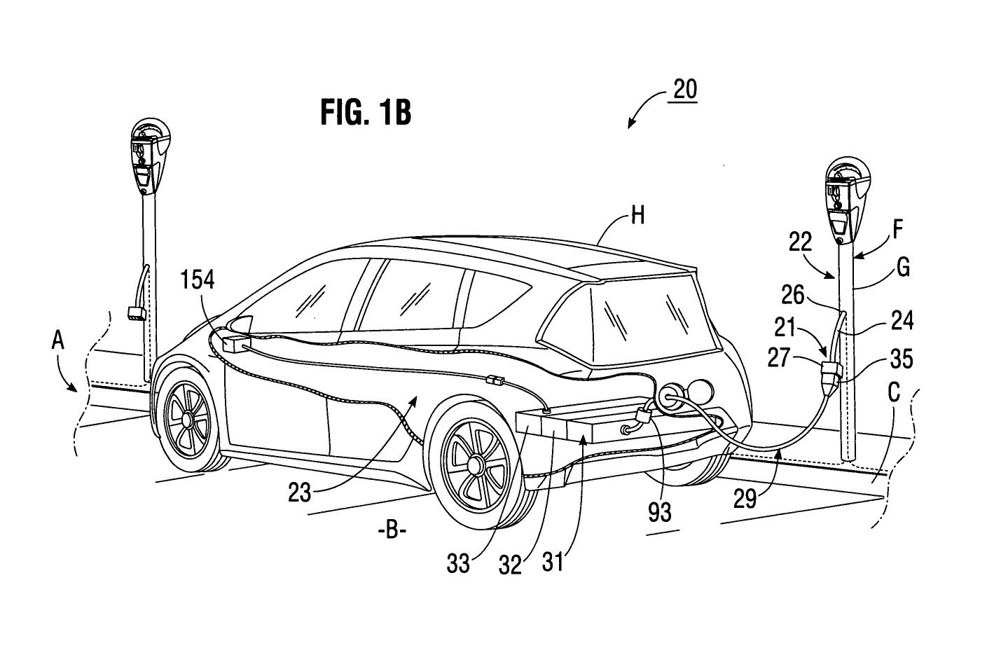

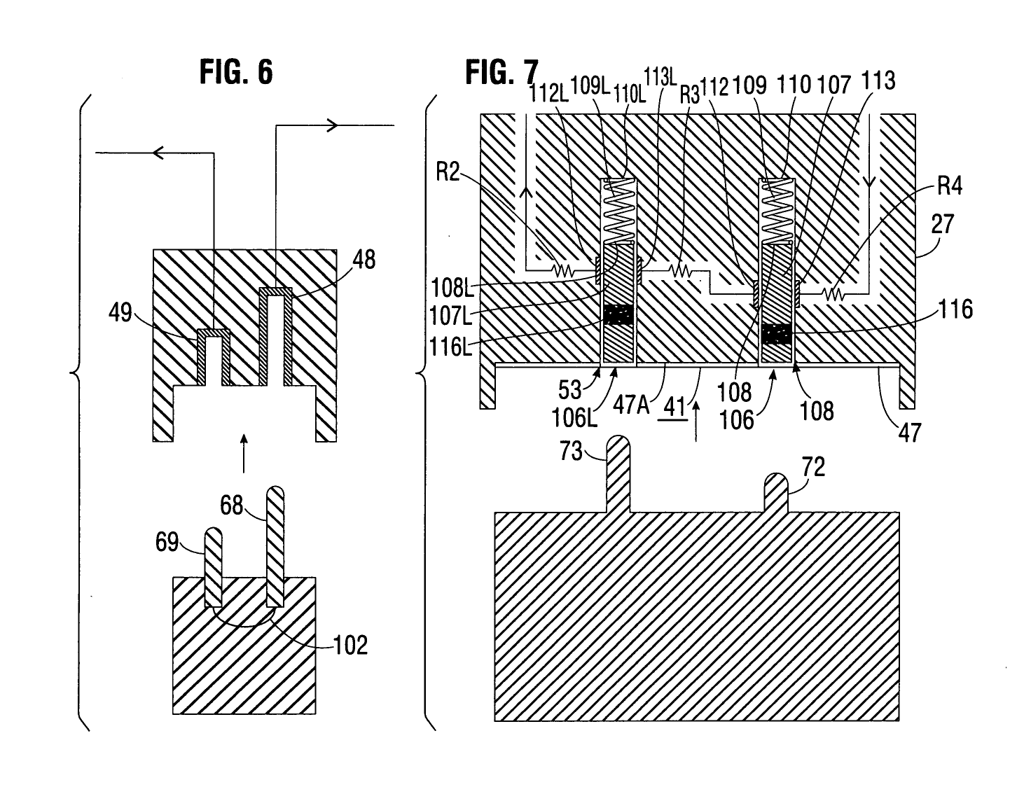

FIGS. 1-12 illustrate a system for charging electric vehicle batteries from street lights and parking meters according to the present invention.

Referring first to FIG. 1A, a street or road A is shown which includes a roadway B, a curb C, street lights D having standards E, and parking meters F having standards G located adjacent to the curb. Referring to FIGS. 1A and 1B, it may be seen that a Charging System 20 for charging batteries of electric vehicles H includes a retrofit or modification apparatus 21, for converting street lights D and/or parking meters F into dual function fixtures which function as Charging Stations 22 for electric vehicles in addition to their original functions of illuminating a street or receiving parking fees.

As may be seen best by referring to FIG. 1B in addition to FIG. 1A, system 20 for charging batteries of electric vehicles includes in addition to Charging Station 22 an On-Board Charge Control System 23 installed in electric vehicle H, which comprises with Charging Station 22 a complete charging system 20.

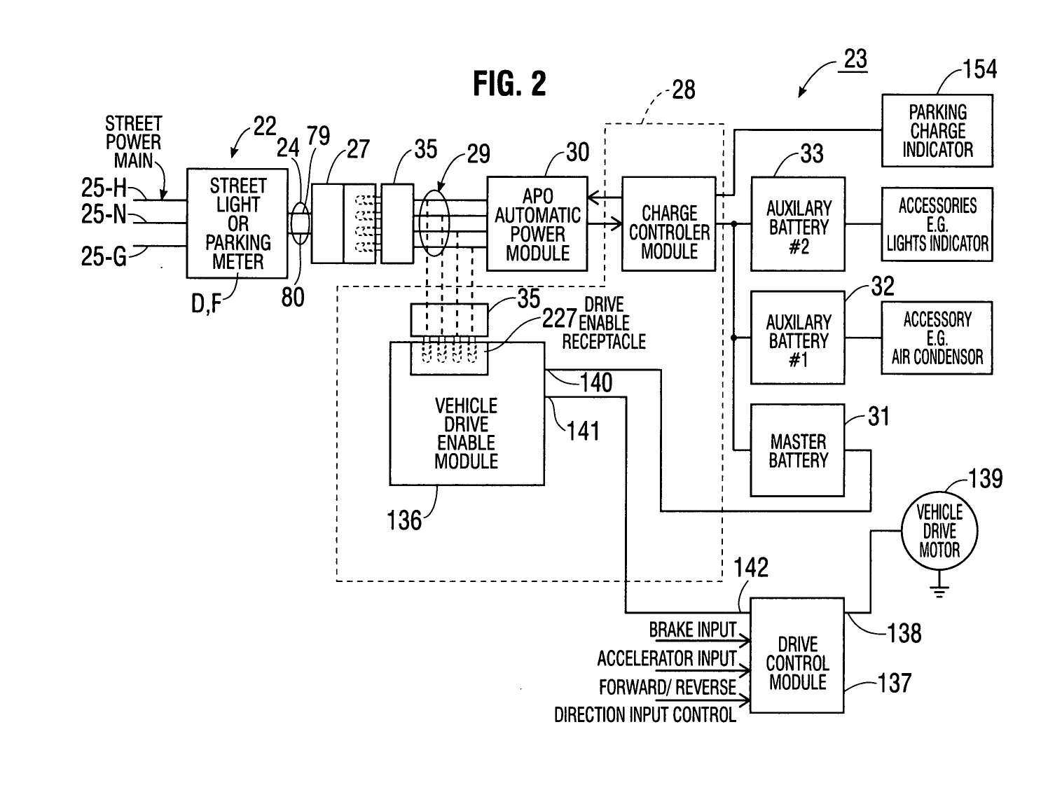

As shown in FIGS. 1B and 2, charging station 22 includes a multi-conductor insulated electric charging station cable 24 which has multiple conductors 25, e.g., hot, 25-H, neutral, 25-N and ground 25-G which are connected in parallel with corresponding conductors of existing power mains conductors wired to standard E of a street light D or standard G of a parking meter F.

As may be seen best by referring to FIG. 1B, charging station cable 24 protrudes through an opening 26 in lamp standard E or parking meter standard G, and is terminated at an outer end of the cable by a keyed electrical power receptacle 27 of novel design and construction. Although the figures show charging station cable 22 protruding some distance from opening 26, receptacle 27 may be optionally mounted directly on a standard E or other part of street lamp D, or directly on standard G or other structural component of parking meter standard G, to further secure the cable against tampering.

As may be seen best by referring to FIG. 1B, On-Board Charge Control System 23 of Charging System 20 according to the present invention includes a Charging Current Controller module 28, and a vehicle charger cable assembly 29. As is shown in FIG. 2 and described in detail below, an inner, load side of vehicle charger cable assembly 29 is connected through an Automatic Power Off (APO) module 30 and Charging Current Controller module 28 to a master battery 31 and auxiliary batteries 32, 33 within vehicle H.

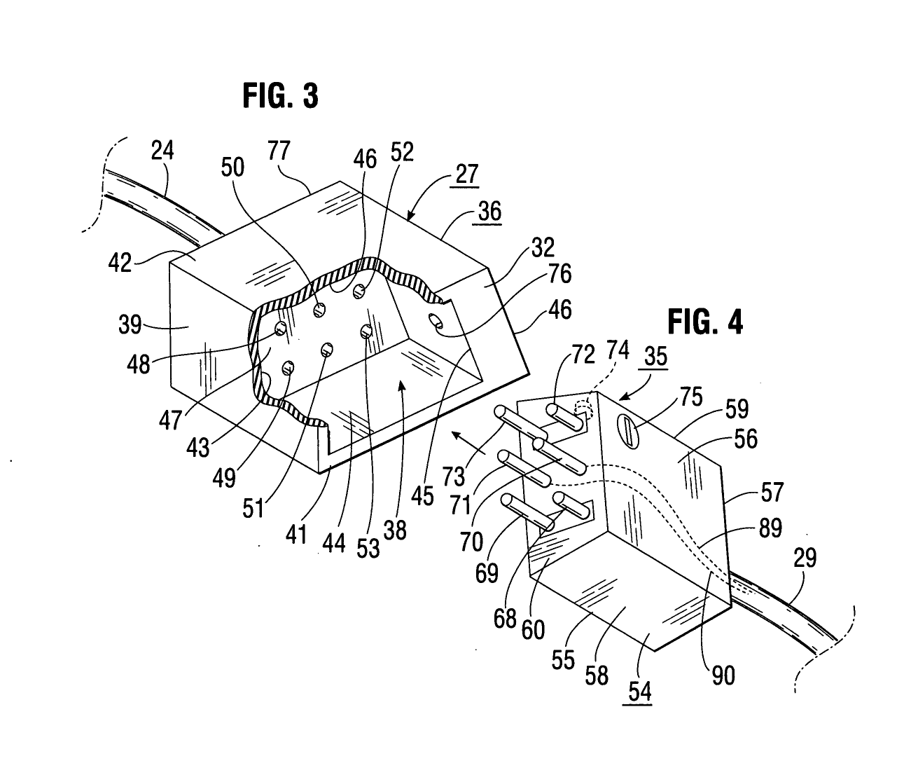

FIGS. 3-7 illustrate details of a novel tamper resistant, weather resistant receptacle and plug arrangement of electric vehicle Charging System 20 according to the present invention. As shown in FIGS. 3 and 4, electric vehicle Charging System 20 includes a charging station receptacle 27 located at the outer end of charging station cable 24, and a vehicle charger cable plug 35 located at the outer end of vehicle charger cable assembly 29.

As shown in FIG. 3, receptacle 27 includes a block-shaped body 36 made of a durable, electrically non-conductive polymer such as hard rubber. Body 36 has extending inwardly from a front transverse face 37 thereof a polygonally-shaped recess 38 which is laterally offset from a laterally centered position between left and right side walls 39, 40 of body 36. Also, as shown in FIG. 3, body 36 preferably has a laterally asymmetric shape, including a vertical left side wall which protrudes perpendicularly upwards from a flat, rectangular plan view base 41 to a flat, rectangular upper surface 42, and a right side wall 40 which angles upwardly and inwardly towards a vertical center plane of body 36.

As shown in FIG. 3, polygonally-shaped recess 38 of receptacle 27 has a left inner side wall 43 disposed parallel to outer left side wall 39 of body 36, a lower inner side wall 44 disposed parallel to bottom outer side wall 41, an inner angled right side wall 45 disposed parallel to outer angled right side wall 40, and an upper inner side wall 46 disposed parallel to outer upper wall 42 of receptacle body 36.

As is also shown in FIG. 3, recess 38 in front face 37 of plug body has in transverse cross-section the shape of an irregular trapezoid which has parallel upper and lower horizontal sides, a vertical left side, and an upwardly and inwardly angled right side.

As shown in FIG. 3, trapezoidally-shaped recess 38 of receptacle 27 extends rearwardly or inwardly from front face 37 of body 36 of receptacle 27 to a rear transversely disposed, vertical inner end wall or bulkhead 47.

Vertical rear bulkhead 47 of receptacle body 36 has extending perpendicularly inwardly from front face 47A thereof a plurality of electrically conductive sockets or ferrules 48, 49, 50, 51, 52 and 53.

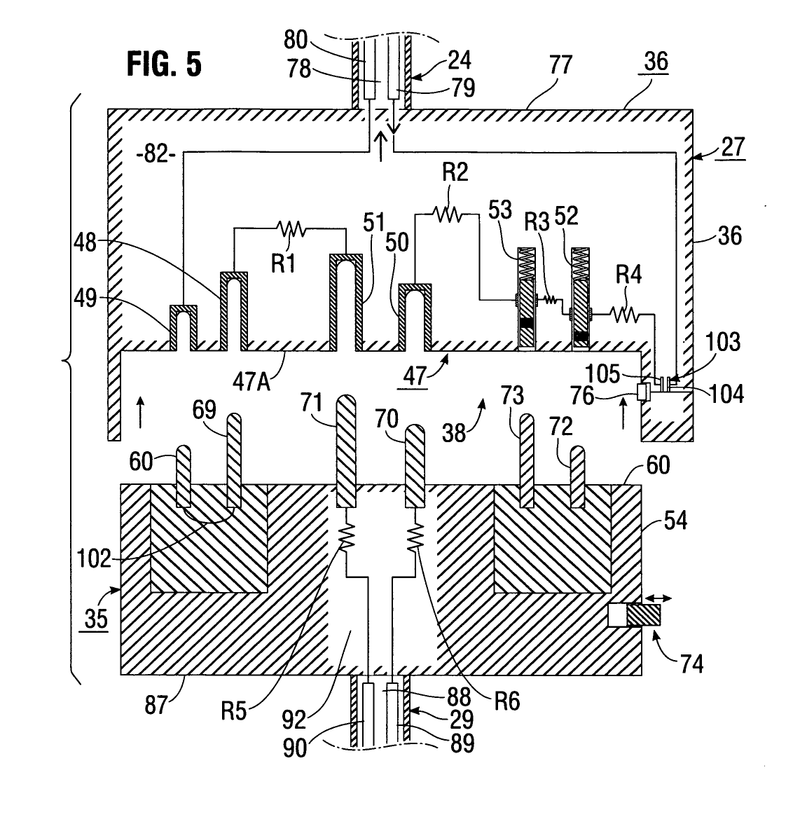

As shown in FIG. 4, sockets 48-53 are preferably arranged as three parallel vertical columns of pairs of ferrules, such as a left-hand pair including upper ferrule 48 and lower ferrule 49, a middle pair including upper ferrule 50 and lower ferrule 51, and a right-hand pair including an upper ferrule 52 and a lower ferrule 53. However, it should be understood that the six ferrules 48-53 could optionally be arranged differently, as for example, all in a single horizontal plane. This alternate, horizontally aligned optional arrangement is shown in FIG. 5, primarily as a matter of convenience in a semi-diagrammatic view of the receptacle 27 shown in FIG. 3.

Referring now to FIG. 4 in addition to FIG. 3, it may be seen that vehicle charger cable plug 35 has a block-shaped body 54 made of a durable electrically insulating material such as hard rubber. Body 54 has a flat, rectangular plan-view lower wall or base 55, a similarly shaped upper wall 56, and a vertically oriented, rectangularly shaped rear transverse face 57.

As shown in FIG. 4, body 54 of plug 35 has a rectangularly shaped, vertically oriented left side wall 58, and a rectangularly shaped right side wall 59 which is disposed between lower and upper side walls 55 and 56, and angles upwardly and inwardly towards the vertical longitudinal center plane of body 54 of the plug. Thus constructed, plug 54 has a uniform trapezoidally-shaped transverse cross section which is of the proper size and shape to be able to be inserted conformally into recess 38 of receptacle 27.

As shown in FIGS. 3 and 4, plug 35 has protruding from a front trapezoidally-shaped face or bulkhead 60 of body 54 of the plug, three pairs of electrically conductive pins 68, 69, 70, 71 72 and 73. The plug pins are arranged to fit into corresponding receptacle socket ferrules 48, 49, 50, 51, 52 and 53, respectively, when plug body 54 is inserted into recess 38 of receptacle 27.

As shown in FIGS. 3 and 4, plug 35 and receptacle 27 are preferably provided with complementary structural features which cooperate to perform safety and security interface functions in addition to those which are described in detail below. Thus, as shown in FIG. 4, plug 35 preferably has located in right side wall 59 of plug body 54 an interlock pin 74. Pin 74 is normally flush with right side wall 59, but extends outwardly from the right side wall if a key (not shown) is inserted into a key slot 75 in upper wall 56 of plug body 56, and turned. As may be understood by referring to FIG. 3 in addition to FIG. 4, pin 74 is receivable into a bore 76 which extends into inner right side face 45 of receptacle 27.

FIGS. 5-7 illustrate safety and security interlock features of plug 35 and receptacle 27. In FIGS. 5-8, resistors R1-R6 represent contact resistances between various pin-socket interfaces when plug 35 is inserted fully into receptacle 27.

As shown in the semi-diagrammatic view of FIGS. 5 and 7, socket ferrules 48-52 of receptacle 27 and corresponding, complementarily located pins 68-73 of plug 35 are each shown as lying along a single horizontal line, such as on a horizontally disposed mid-plane of the receptacle and plug, respectively. Although this linear arrangement may optionally be used, and is shown fir facilitating the following description of plug 35 and receptacle 27, the preferred arrangement of ferrule sockets and mating plug pins is three vertical columns of pairs of connectors, as shown in FIGS. 3 and 4.

Referring now to FIGS. 4 and 5, it may be seen that charging station cable 24 is secured at an outer end thereof to the rear wall surface 77 of receptacle 27. Charging station cable 24 has disposed through the length of its interior a bore or lumen 78 in which are disposed hot and neutral insulated wires 79, 80 that protrude through an opening 81 in the rear wall 77 of body 36 of receptacle 27, into a hollow interior space 82 of the body located inward or rearward of rear bulkhead 47 of the receptacle.

As may be understood by referring to FIGS. 1B and 2, the center conductor of insulated hot wire 79 of charging station cable 24 is connected at an upstream or input end of the cable located at a parking meter or street light to the hot wire 25H of a power mains cable which supplies power to the parking meter or street light. Also, the center conductor of the neutral or return wire 80 of charging station cable 24 is connected at an upstream or input end of the cable to the neutral or return wire 25N of a power mains cable which serves the parking meter or street light.

Referring again to FIGS. 4 and 5, it may be seen that vehicle charger cable 29 is secured at an outer end thereof to the rear wall 87 of vehicle charger plug 35. Vehicle charger cable 29 has disposed through its interior bore or lumen 88 hot and neutral insulated wires 89, 90 which protrude through an opening 91 in the rear wall 87 of body 54 of plug 35 into a hollow interior space 92 of the body located inward or rearward of front bulkhead 60 of plug body 54.

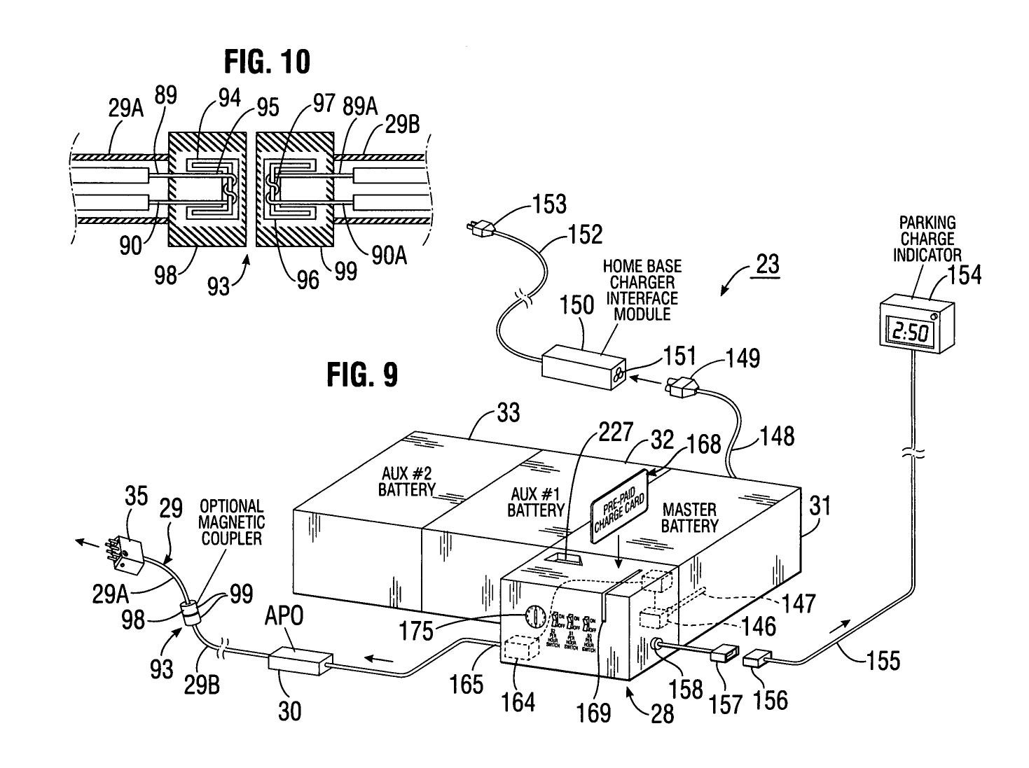

As shown in FIGS. 1B, 9 and 10 the downstream or load end of vehicle charger cable 29 is connected to the on-board vehicle charge control system 23, preferably by means of an inductive magnetic coil coupler 93. As may be seen best by referring to FIG. 10, Inductive magnetic coil coupler 93 consists essentially of a transformer which has a primary laminated ferromagnetic core half 94 wound with a primary coil 95 which is connected to conductors 89 and 90 of vehicle charger cable 29, and a secondary laminated magnetic core half 96 wound with a secondary coil 97 which outputs charging current to on-board vehicle charge control system 23. The primary and secondary transformer cores of inductive magnetic coil coupler 93 are located into two separable, primary and secondary housings 98, 99, which when spaced closely together, enable a charging current to be induced in the secondary coil when the primary coil is energized by current supplied by conductors 89 and 90. As shown in FIGS. 9 and and 10, when apparatus 20 uses optional inductive coupler 93, vehicle charger cable 29 separated into an input segment 19A connected to plug 35, and an output segment 29B connected to on-board charge control system 23.

Preferably, magnetic coil coupler 93 contains within secondary housing 99 thereof current limiting and over-voltage protection circuitry which ensures that only suitably limited voltages and currents are supplied to on-board vehicle charge control system 23.

As will now be explained, the novel design and construction of receptacle 27 and plug 35 according to the present invention provide a secure means of conducting electrical power supplied by street power mains to conductors 79 and 80 of charging station cable 24 to conductors 89 and 90 of vehicle charger cable 29.

Referring now to FIGS. 5, 6 and 7, it may be seen that a complete electrical circuit path between neutral wire 80 of charging station cable 24 and neutral conductor 90 of vehicle charger cable 29 may be provided if the following conditions are met:

(1) Plug 35 is inserted into recess 38 of receptacle 27.

(2) There is an electrically conductive path between neutral wire 90 of vehicle charger cable 29 and lower middle pin 51 of plug 35.

(3) Pin 71 of plug 35 is inserted into socket ferrule 71 of receptacle 27 and makes electrical contact with socket 51.

(4) Pin 68 of plug 35 is inserted into socket ferrule 48 of socket ferrule 48 of receptacle 27 and makes electrical contact with socket 48.

(5) Pin 69 of plug 35 is inserted into socket ferrule 49 of receptacle 27 and makes electrical contact with socket 49.

(6) There is an electrically conductive jumper wire 102 electrically conductively connected between pins 68 and 69 of plug 35.

Also, a complete electrical path between hot wire 79 of charging station cable 24 and hot wire 89 of vehicle charger cable 29 may be provided if the following conditions are met:

(1) Plug 35 is inserted into recess 38 of receptacle 27 sufficiently far for interlock pin 74 in the right side 59 of body 54 of the plug to be aligned with bore 76 in right inner side wall 45 of receptacle 27.

(2) A key is inserted into key slot 75 of plug 35 and turned to thereby extend interlock pin 74 into bore 76 sufficiently far for the pin to operate an electrical contactor switch 103 which is connected in series with hot wire 79 of charging station cable 24, and upper right-hand socket ferrule 52 of receptacle 27, thus closing a circuit between input terminal 104 and switched output terminal 105 of the contactor switch.

(3) An electrically conductive path is established between switched output terminal 105 of contactor 103 and socket ferrule 50 of receptacle 27, in the following manner.

Referring to FIGS. 5 and 7, it may be seen that right-hand socket ferrules 52 and 53 of receptacle 27 are of a novel design and construction.

As shown in FIG. 7, socket ferrule 52 includes a blind bore 106 which extends perpendicularly inwardly or rearwardly into the front face 47A of rear bulkhead 47 of receptacle 37. Bore 106 has a uniform circular cross-section and contains therein an elongated, cylindrically-shaped insulating peg 107 which is longitudinally slidable within bore 106. Peg 107 is attached at an inner transverse end 108 thereof to an outer end of a compression spring 109, the other end of which is attached to the inner transverse end wall 110 of bore 106. As shown in FIGS. 5 and 7, peg 107 is urged longitudinally outward in bore 106 to thus position the outer transverse end face 108 of the peg a short distance inwards of rear bulkhead face 47A of receptacle 27.

As may be seen best by referring to FIG. 7, a pair of opposed semi-cylindrically-shaped electrically conductive ring segments 112, 113 are recessed in body 36 of receptacle 27, the ring segments having a common central bore 114 which coaxially circumscribes and protrudes slightly inwardly into blind bore 106. As is also shown in FIG. 7, insulating peg 107 has affixed to its outer cylindrical wall surface 115 a resilient conductive ring 116, which is located a first distance longitudinally inwards of the outer transverse face 108 of the peg. With this arrangement, when peg 107 is pressed longitudinally inwards a suitable distance into bore 106 against the spring bias force of spring 109, resilient conductive ring 116 on peg 107 makes electrically conductive contact between fixed semi-cylindrically-shaped ring segments 112, 113, thus completing an electrically conductive path between the fixed ring segments.

Referring to FIGS. 5 and 7, it may be understood that electrically conductive contact may be made between fixed semi-cylindrically-shaped ring segments 112, 113 and movable conductive ring 116 only if insulating peg 107 has been depressed a predetermined distance inward of front face 47A of rear bulkhead 47 of receptacle 27. As may be understood by referring to FIGS. 5 and 7, peg 107 may be depressed the aforementioned required distance by an insulating pin 72 of appropriate length which protrudes forward from front face 60 of body 54 of plug 35, when the plug is inserted into recess 38 of receptacle 27. If pin 72 is longer or shorter than the required predetermined length, bridging electrical contact between semi-cylindrically-shaped ring segment conductors 112, 113 will not be achieved.

Referring still to FIGS. 5 and 7, it may be seen that left-hand or lower socket 53 of receptacle 27 has a construction substantially similar to that of socket 52 described above, including elements designated 106L-116L, which are exactly analogous in structure and function to corresponding elements 106-116 of right-hand, or upper socket 52 described above. Socket 53 differs in construction from socket 52 substantially only in the respect that semi-cylindrically-shaped conductive ring segments 112L, 113L and resilient conductive ring 116L on plug 107L, are spaced at different distances inward of front face 47A of receptacle bulkhead 47 than the corresponding distances of components of right-hand socket 52. Thus, as may be understood by referring to FIGS. 5 and 7, electrically bridging contact between fixed conductive ring segments 112L and 113L of left-hand socket 52 will be made by conductive ring 116L on peg 107L only if a pin 73 of a proper length, different from that of pin 72, is inserted into bore 106L when plug 35 is inserted into receptacle 27. As may be understood by referring to FIG. 5, when a plug 35 which has pins 72, 73, each of different predetermined length, is inserted into recess 38 of receptacle 27, a complete electrically conductive path will be achieved between hot wire 79 and socket 50 of the receptacle, thus enabling charging current to flow from power mains to the two conductors 89, 90 of vehicle charger cable 29.

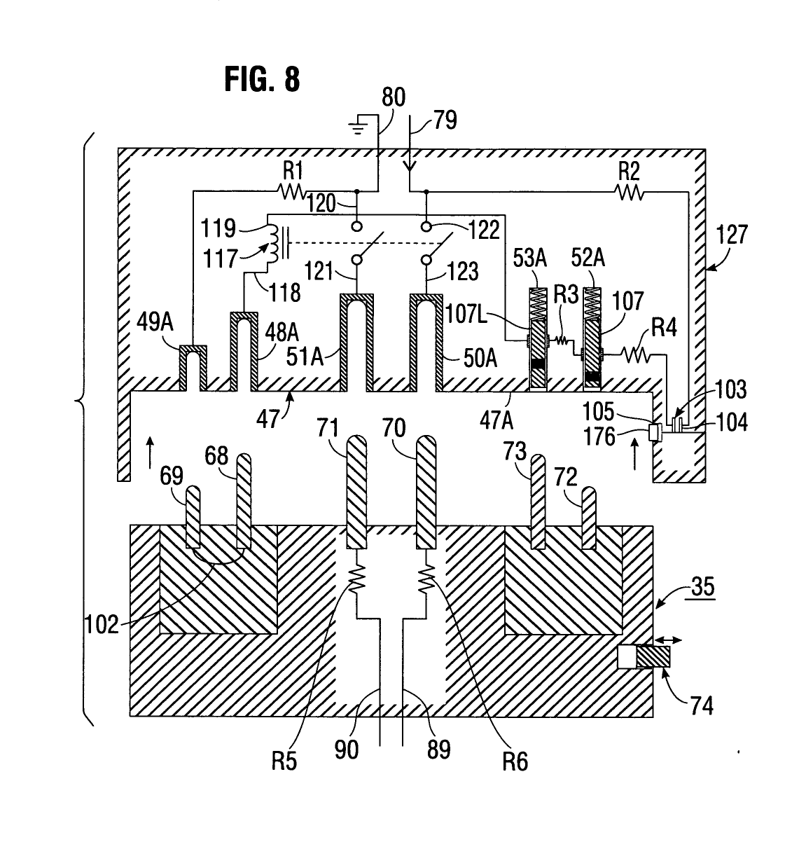

FIG. 8 illustrates a modification 127 of receptacle 27 shown in FIG. 5 and described above. Modified receptacle 127 includes an electromagnet or solid state contactor relay 119 to enable current flow from power mains conductors 79, 80 in charging station cable, to receptacle power socket ferrules 150, 151, and then to pins 70, 71 of plug 35, and conductors 89, 90 of vehicle charger cable 29. Thus, as shown in FIG. 8, relay 117 of modified receptacle 127 has coil or input terminals 118, 119 which require only a small sampling current of, for example, 10 to 100 milliamps to complete circuit paths through relay contact pairs 120, 121 and 122, 123 for neutral and hot wires 80, 79, respectively, of charging station cable 24 to hot wires 90, 89, respectively, of vehicle charger cable 29.

As shown in FIG. 8, relay 117 is actuated to make contact between the foregoing pairs of conductors when a small sensing current is provided to the contactor relay input terminals 118-119, via the following path:

(1) From hot power mains conductor 79 through key operated contactor switch 103 and resistance R1.

(2) Through coded length socket and pin pairs 72-52A, 73-53A, respectively.

(3) Through input terminals 118, 119 and coil 124 of relay 117.

(4) Through conducive socket pin pairs 48A-68, 69-49A, and jumper wire 102.

(5) Through resistance R2 to conductor 80 connected to power mains neutral conductor 80.

The advantage of the modified receptacle 127 shown in FIG. 8 is that it only requires a small sampling current of the order of about 10 ma to about 100 ma to confirm that a properly coded plug 35 has been inserted into receptacle 127, and thus allow charging current to flow to the plug. Therefore, pins 68, 69, 73 and 72, and sockets 148, 149, 153 and 152 can be of lightweight, light duty construction, and only pins 70 and 71 and sockets 150 and 151 need to have a high-current carrying capability.

FIGS. 2 and 9-12 illustrate additional structural and functional details of the system 20 for charging electric vehicles according to the present invention.

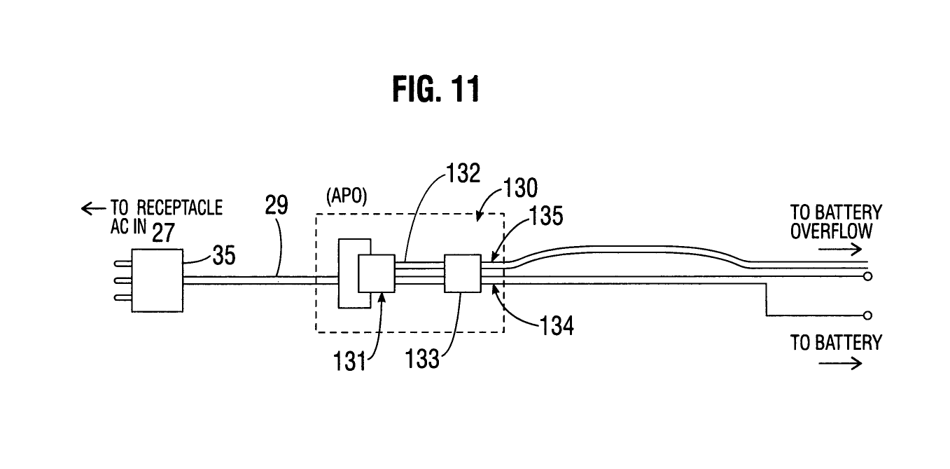

As shown in FIGS. 2 and 11, if a properly coded and keyed vehicle charger cable plug 35 is inserted into a keyed charging station receptacle 27, an AC voltage from street electric power mains supplying a street light D or parking meter G with electrical power is conducted, optionally through an inductive magnetic coupler 93, to Automatic Power Off (APO) module 30. As shown in FIG. 11, APO 30 includes a power contactor 131, which, if provided on an input terminal 132 thereof with a charging station access enable signal from Charging Current Controller Module 28, enables power mains current to be conducted to a current and voltage regulator module 133 in the APO.

As shown in FIGS. 2 and 11, current and voltage regulator module 133 of APO 30 has a two-terminal battery charger current output port 134, which outputs battery charging current to charger controller module 28. Current and voltage regulator module 133 also has a two-terminal signal input port 135 which is connected to battery over-voltage, over-charge rate sensors (not shown) connected to batteries 31, 32 and 33, and which causes the current and voltage regulator module to reduce or cease charging current output upon detection of an over-voltage or over-current condition.

Referring to FIG. 2, it may be seen that on-board vehicle charge control system 23 of charging system 20 includes a vehicle drive enable module 136. Vehicle drive enable module 136 is connected in series with master battery 31 and a drive control module 137. Drive control module 137 has brake, accelerator and forward/reverse direction control input ports, and an output port 138 which is connected to a vehicle drive or traction motor 139.

As shown in FIG. 2, vehicle drive enable module 136 has a battery power input port 140 which is connected to output terminals of master battery 31, and an output port 141 connected to drive current input port 142 of drive control module 137. Vehicle drive enable module 136 contains a power contactor (not shown) which permits current from master battery 31 to flow through the vehicle drive enable module to the drive current input port of the vehicle drive control module only if plug 35 at the end of vehicle charger cable 29 is removed from a charging station receptacle 27 and inserted into a similarly constructed receptacle 227 on the vehicle drive enable module, thus ensuring that the vehicle driver will not inadvertently drive away while plugged into receptacle 27.

FIGS. 2, 9 and 12 illustrate details of on-board vehicle charge control system 23 which enable a vehicle to obtain electrical power from a street charging station 22 only if a special pre-paid charge authorization device such as magnetically or electronically encoded card such as a SIM card 168 is inserted into a card reader slot 169 in Charging Current Controller Module 28. As shown in FIGS. 9 and 11, Charging Current Controller Module 28 has on a control panel 1640 thereof a bank of three on-off rocker switches 161, 162 and 163.

Charging Current Controller Module 28 contains a card reader, such as a magnetic or electronic card reader 170 of a design and construction well-known to those skilled in the art, which will output a logic true charge authorization signal as long as a pre-paid money balance remains encoded on a special pre-paid charge card 168. Charging Current Controller Module 28 also contains a contactor 164 which closes an electrical circuit between input charging current power port 165 of switches 161-163, output port 166 of the Charging Current Controller Module, and input terminal port 167 of batteries 31, 32 and 33.

As long as prepaid charge card 168 contains a money balance, contactor 164 of Charging Current Controller Module 28 enables charging current selected by closing switches 161, 162 and 163 to flow into batteries 31, 32 and 33, respectively.

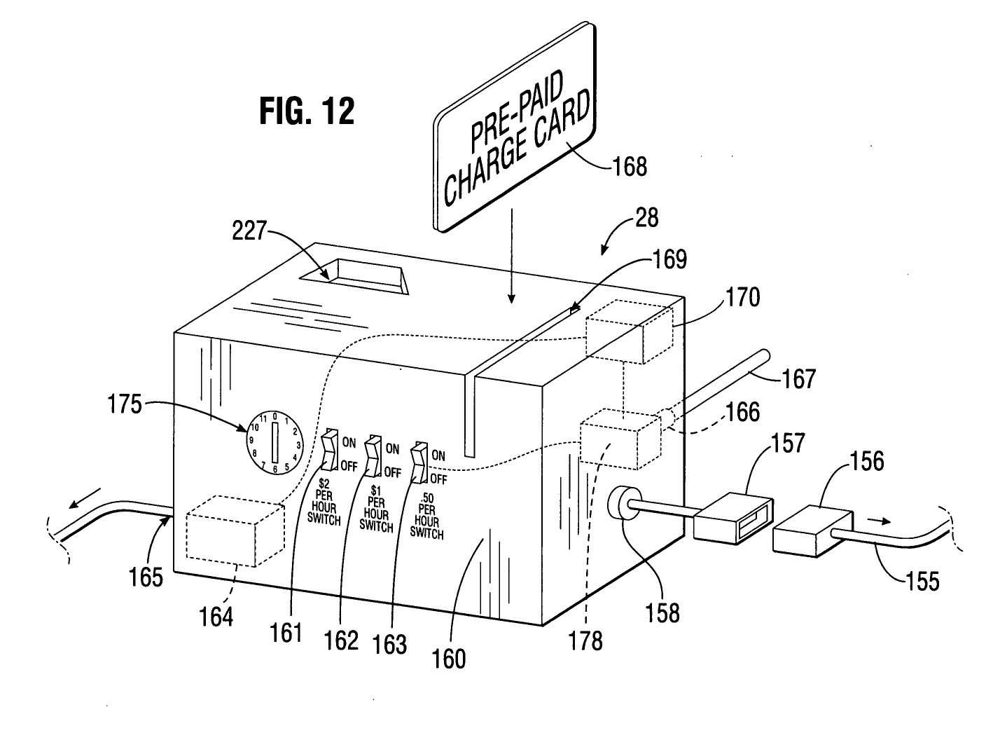

As shown in FIG. 12, Charging Current Controller Module 28 contains an electrical energy consumption measurement device such as a watt-hour meter or coulomb charge meter 178 which produces an output signal proportional to the total charge in coulombs, or energy in watt-hours used while charging batteries 31, 32 or 33. Electrical energy consumption device 178 outputs a signal proportional to consumed power or energy to card reader 170, and deducts from a money balance on a prepaid charge card 168 an amount equal to the product of consumed energy or current times a predetermined cost per unit of energy or current. When the balance decreases to zero, card reader 170 removes a charging station access enable signal to contactor 164 of Charging Current Controller Module 28, and/or charge enable input control terminal 132 of APO 30, thus preventing a vehicle from obtaining any more charging current from a street charging station 22, until a different charge card 130 having a positive money balance is inserted in the card reader slot 139 of the Charging Current Controller Module.

As shown in FIG. 9, master battery 31 includes a home-base charging system for charging the battery from a home-base charger, including a home base battery charger cable 148 which is connected at one end thereof to terminals of the master battery and is termiated at the other end of the cable by a plug 149. The home-base charging system includes a charger interface module 150 which includes rectifiers and current and voltage regulator components for rectifying AC power and regulating DC charging current. Interface module 150 has an electrical output receptacle 151 for receiving home base battery charger cable plug 149, and an AC electrical input cord 152 terminated in a AC power plug 153 insertable into a home base power receptacle (not shown).

As shown in FIGS. 2, 9 and 12, on-board vehicle charge control system 23 preferably includes a parking charge paid indicator 154 which is connected through a cable 155 of plug 156, receptacle 157 to a signal output port 150 of Charging Current Controller Module 28. As shown in FIGS. 1B and 9, parking charge indicator is positioned within vehicle H at a position where a display window on the indicator is viewable through a window of the vehicle from outside the vehicle. The parking charge paid indicator 154 indicates that a vehicle H is legally parked at a parking meter, and authorized to receive electrical charging power, as long as a positive money balance remains on a charge card 168 inserted into card reader slot 169 of Charging Current Controller Module 28.

As shown in FIGS. 9 and 12, on-board vehicle charge control system 23 also preferably includes a time-remaining meter 175. Meter 175 receives input signals proportional to electrical charging current from charging current meter 178 and a signal from card reader 170 which indicates the money balance remaining on charge card 168. Based ;upon this information, meter 175 calculates an estimated time remaining until the money balance on charge card 168 is reduced to zero. The estimated remaining time is displayed on meter 158 and parking charge paid indicator 154.

Optionally, parking charge paid indicator 154 may be supplemented or replaced by a Radio Frequency Identification (RFID) chip which is included in charge card 168. With this option, charge authorization personnel such as police or meter maids may use a hand-held or patrol vehicle-mounted radio frequency transponder interrogation device, similar to a radar speed gun, to interrogate a vehicle being charged at a street charging station, confirm identity of a charging card 168, and confirm that a positive money balance remains on the card. The structure and function of such verification system are well known to those skilled in the art, and are in wide use as components of electronic toll collection (ETC) systems, such as the FasTrak system used in the State of California in the United States.

In another optional modification of a vehicle charging system 20 according to the present invention, charge authorization, and actuation of charging power enabling contactor relay 117 in receptacle 27, may be accomplished by using a communication and control system using communications between satellite and radio-frequency transceivers located in either or both a vehicle and receptacle 27. Such satellite based communication and control systems are well known to those skilled in the art, and are in wide use in the United States and other countries to provide roadside assistance to operators of vehicles equipped with special radio transceivers which can communicate through orbiting space satellites with a central control station, and marketed under the name OnStar.

Another optional modification of the charge system 20 according to the present invention includes a modified receptacle 27 which has a movable cover plate or door which covers the sockets of the receptacle from weather and tampering, the door being operable by an electro-mechanical actuator such as an electric motor or solenoid only if a properly coded magnetic card or RFID chip is presented to the receptacle.

Another optional modification of the charge system according to the present invention includes relocating at least the charge-card authorization mechanism of the charge controller module 28 shown in FIGS. 2, 9 and 12 to a fixed installation within or adjacent to the keyed electrical power receptacle 27 shown in FIG. 3.

What is claimed is:

1. A charging system for charging electric vehicle batteries using electrical power supplied to public fixtures by power mains, said system comprising;
a. a charging station including a power interface module connectable to power mains conductors fed into a public fixture, said power interface module including a keyed receptacle for conducting electrical power from said power mains to a complementarily keyed plug insertable into said receptacle,
b. an electric vehicle battery charger cable terminated at an input end thereof by a plug keyed complementarily to said keyed receptacle, and
c. a vehicle charge control system, said vehicle charge control system including,
i. a pre-paid charge authorization payment device having a money balance,
ii. a charging station access enable device responsive to a money balance in said payment device in providing on a control signal output port thereof a charging station access enable signal, said charging station access enable device being responsive to an input signal on in input signal port thereof an input signal proportional to the quantity of consumed electrical energy measured by an electrical energy consumption measurement device in deducting from said money balance an amount proportional to said consumed electrical energy, said access enable device providing on said control signal output port thereof an access enable signal for as long as said money balance is greater than zero,
iii. at least a first current conducting contactor having a first contactt port connected to an output load end of said vehicle charger cable, a second contact port connected to a charging current regulating apparatus effective in inputting charging current to batteries within an electrical vehicle, and a control signal input port connected to said control signal output port of said charging station access enable device, said contactor effecting electrically conductive contact between said first and second contact ports as long as a money balance remains on said pre-paid charge authorization payment device, and
iv. an electrical energy consumption measurement device for measuring consumption of electricity used in charging batteries of a vehicle, said measurement device being connected in series with said contactor and said charging current regulating apparatus and having a signal output port on which occurs a signal proportional to consumed electric energy, said signal output port being operatively interconnected to said input port of said access enable device and thereby effecting decrementing a money balance on said pre-paid charge authorization payment device a money amount equal to the product of electrical energy consumed times a predetermined cost per unit of electrical energy.

2. The charging system of claim 1 wherein said pre-id charge authorization payment device is further defined as including at least one of a magnetically encoded charge card, electronically encoded charge card, an RFID chip, and a radio frequency transceiver linkable to a charge authorization transceiver.

3. The charging system of claim 1 wherein said keyed receptacle includes at least two power conductor sockets and a first combination of two first bridging sockets, said receptacle conducting electrical power to said power conductor sockets only if a plug containing correctly encoded bridging pins is inserted into said receptacle.

4. The charging system of claim 3 wherein said receptacle is so constructed as to require an electrically conductive bridge to exist between said first combination of two bridging pins of said plug.

5. The charging system of claim 4 wherein said receptacle has a second combination of two second type bridging sockets, said receptacle being enabled to conduct electrical power to said power conductor sockets of said receptacle only if a plug is inserted into said receptacle, said plug having a correctly coded first type of two bridge pins received in said first combination of bridge sockets, and a correctly coded combination of two second type pins is insertably received into said second type combination of bridging sockets.

6. The charging system of claim 5 wherein at least one of said bridging sockets includes in combination;
a. a bore which extends inwardly from a mating face of one of a receptacle and mating plug,
b. an insulating cylindrical peg longitudinally slidably located within said bore, said peg being urged outwardly within said bore to thus position an outer face of said peg near said mating face, said peg having fixed to an outer cylindrical surface thereof an electrically conductive ring, said ring being located at a first distance inward of an outer transverse face of said peg,
c. a pair of fixed radially opposed semi-cylindrically-shaped electrically conductive ring segments which coaxially encircle said bore, said fixed ring segments being simultaneously contactable by said conductive ring of said peg to complete an electrical circuit between said ring segments when said peg is depressed inwardly of said mating face a first coded distance by an insulating pin protruding from a mating face of one of a mating plug and receptacle and having a length equal to said first coded distance.

7. The system of claim 3 wherein said keyed receptacle is further defined as including a relay having a two-terminal input control port wired in series with a first, above-ground potential power mains conductor, said first two bridging sockets of said receptacle, and a second, neutral return potential power main conductor, said relay having at least one pair of normally open contact output terminals connected in series with one of said power conductor sockets of said receptacle and one of said power mains conductors, said relay being actuateable to electrically connect said pair of output contact terminals together when a pair of electrically connected bridging pins of said keyed plug are inserted into said keyed receptacle.

8. The charging system of claim 1 wherein said keyed receptacle includes a contactor switch connected in series with at least one of said power mains conductors and at least one power output socket of said receptacle, said contactor switch being actuateable by a key operated member contained in said keyed plug.

9. The charging system of claim 8 wherein said key operated member of said keyed plug is further defined as being one of a multi-pin tumbler key, electrically encoded card, a magnetically encoded card, and an RFID chip.

10. The charging system of claim 1 wherein said vehicle charge control system includes a vehicle drive enable module which is interconnected with a vehicle drive control module so as to disable power transfer from vehicle batteries through said vehicle drive control module to a vehicle traction motor when said plug is inserted into said keyed power output receptacle.

11. The charging system of claim 10 wherein said vehicle drive enable module includes a keyed vehicle-mounted receptacle which requires said keyed plug of said vehicle charger cable to be removed from said power output receptacle of said charging station and inserted into said vehicle-mounted receptacle to enable power transfer from said vehicle batteries to said vehicle traction motor.

12. The vehicle charging contact system of claim 1 wherein said vehicle charge control system includes a paid indicator for indicating that a vehicle is authorized to be receiving electrical charging power form said power interface module connected to power mains, said paid indicator being operatively interconnected to said pre-payment recognition device and confirming that said pre-payment recognition device has been properly engaged by said pre-charge authorization device having therein a positive money balance, said confirmation being transmitted to a location exterior to said vehicle by at least one of a visual display, RFID chip, radio frequency or infrared signal.

13. The charging system of claim 1 wherein said charge control system is an on-board vehicle charge control system mounted in an electrically powered vehicle.

14. The charging system of claim 1 wherein at least said prepaid charge authorization payment device is mounted in said charging station.

15. The charging station of claim 14 wherein said prepaid charge authorization device is further defined as being mounted to said keyed receptacle.
